(19) United States
(12) Patent Application Publication
(10) Pub. No.: US 2006/0019530 A1
(43) Pub. Date: Jan. 26, 2006

(54) Battery pack locking apparatus for portable terminal

(75) Inventor: Hong-Moon Chun, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/133,132

(22) Filed: May 19, 2005

(30) Foreign Application Priority Data
Jul. 21, 2004 (KR) 56883/2004

(51) Int. Cl. H01R 3/00

(52) U.S. Cl. 439/500

(57) ABSTRACT

A battery pack locking apparatus for a portable terminal includes at least one locking groove formed on the battery pack and at least one locking protrusion which is positioned on the terminal in such a manner that it can linearly reciprocate and which is adapted to be engaged with the locking groove while the battery pack is mounted on the terminal, wherein the battery pack is adapted to be released from the terminal as the locking protrusion linearly reciprocate in the locking groove while being engaged with the locking groove. The battery pack locking apparatus is convenient to use because the battery pack, which is held in the mounting groove, is unlocked by simply operating the locking button and is simultaneously separated from the mounting groove.

### PRIORITY

This application claims priority to an application entitled “Battery Pack Locking Apparatus For Portable Terminal” filed with the Korean Intellectual Property Office on Jul. 21, 2004 and assigned Serial No. 2004-56883, the contents of which are hereby incorporated by reference.

### BACKGROUND OF THE INVENTION

1. Field of the Invention

The present invention relates to a portable terminal, and more particularly to a battery pack locking apparatus mounted on a terminal to secure the battery pack in a releasable manner.

2. Description of the Related Art

In general, portable terminals have a battery pack mounted on the rear surface of the body of the terminal housing as a power source. The battery pack is locked by a locking apparatus which is positioned on the body.

Two different methods are currently used to mount the battery pack as follows: according to one method, after an end of the battery pack is engaged with a support groove of the terminal housing by a support protrusion, the battery pack is fastened on a seating surface of the terminal housing. According to the other method, the battery pack is slid to be mounted on the rear surface of the terminal housing by a guide rib.

FIG. 1 is a perspective view showing a portable terminal having a battery pack locking apparatus 16 according to an embodiment of the prior art. As shown in FIG. 1, a portable terminal 10 having a battery pack locking apparatus 16 according to an embodiment of the prior art includes an upper casing frame 12 and a lower casing frame 11, on which a battery pack 14 is mounted.

The lower casing frame 11 has a seating surface 13 formed on the rear surface thereof. The seating surface 13 has connection terminals protruding from an end thereof and a locking apparatus 16 positioned on the other end thereof for securing the mounted battery pack 14.

The battery pack 14 has at least one support protrusion 15 formed on an end thereof to be engaged with the rear end of the terminal housing 10. Although not shown in the drawing, the housing 10 has a support groove formed on the rear surface thereof, in which the support protrusion 15 can be inserted.

When the battery pack 14 configured as above is to be mounted on the body 10, the support protrusion 15 of the battery pack 14 is inserted into the support groove formed on the rear surface of the housing 10. The battery pack 14 is then lowered about the support protrusion 15 toward the seating surface 13 of the housing 10. Consequently, a hook 17 of the locking apparatus 16 is engaged with a groove (not shown) formed on the other end of the battery pack 14. As such, the battery pack 14 is firmly held on the terminal housing 10 by the support protrusion 15 and the locking apparatus 16.

On the other hand, when the battery pack 14 is to be separated from the body 10, the locking apparatus 16 is typically moved along the longitudinal direction of the housing 10 to separate the hook 17 of the locking apparatus 16 from the battery pack 14. The support protrusion 15 is then released from the housing 10 to complete the separation.

FIG. 2 is a perspective view showing a portable terminal 20 having a battery pack locking apparatus 27 according to another embodiment of the prior art. As shown in FIG. 2, portable terminal 20 includes an upper casing frame 22 and a lower casing frame 21, on which a battery pack 24 is mounted.

The lower casing frame 21 has a seating surface 23 formed thereon. The seating surface 23 has a locking apparatus 27 positioned on an end thereof for holding the battery pack 24 and at least one guide rib 26 formed on both lateral surfaces thereof for guiding the battery pack 24 up to the locking apparatus 27. The battery pack 24 has guide tabs 25 formed on both lateral surfaces thereof to be coupled with the guide rib 26 on the seating surface 23.

When the battery pack 24 is to be locked on the portable terminal 20, the battery pack 24 is placed on the seating surface 23 and then slid in a horizontal direction, specifically, in such a direction that it is fastened on the locking apparatus 27 which is positioned on an end of the seating surface 23. The locking apparatus 27 is then moved in the vertical direction. When the battery pack 24 is fastened on the locking apparatus 27, a hook 28 formed on the locking apparatus 27 is locked into a groove (not shown) formed on the battery 24 and prevents the battery pack 24 from being released.

When the battery pack 24 is to be separated from the terminal 20, the locking apparatus 27 is pressed to release the battery pack 24 from the locking apparatus 27. The battery pack 24 is then lifted to separate it from the seating surface 23.

As mentioned above, conventional battery packs can be separated after the locking apparatus is unlocked, and both lateral surfaces of the battery packs are open while they are mounted on the terminal.

However, according to conventional battery pack mounting structure, battery packs are barely released from the seating surface of terminals even in an unlocked state. Users must inconveniently separate the battery packs from the terminals in the unlocked state. In addition, battery packs cannot be firmly held on the terminals, because both lateral surfaces of the battery packs are open, when the battery packs are mounted on the terminals, and they are held either by a locking apparatus and both end portions or by a locking apparatus and a guide rib. When the terminals are used over an extended period of time, the locking apparatus or the guide rib may wear and make it difficult to firmly hold the battery packs.

### SUMMARY OF THE INVENTION

Accordingly, the present invention has been made to solve the above-mentioned problems occurring in the prior art, and an object of the present invention is to provide a battery pack locking apparatus for a portable terminal making it possible to easily mount and separate a battery pack.

Another object of the present invention is to provide a battery pack locking apparatus for a portable terminal capable of improving durability while maintaining a firmly locked state.

In order to accomplish this object, there is provided a battery pack locking apparatus for a portable terminal including at least one locking groove formed on the battery pack and at least one locking protrusion which is positioned on the terminal in such a manner that it can linearly reciprocate and which is adapted to be engaged with the locking groove while the battery pack is mounted on the terminal, wherein the battery pack is adapted to be released from the terminal as the locking protrusion linearly reciprocates in the locking groove while being engaged with the locking groove.

In accordance with another aspect of the present invention, there is provided a battery pack locking apparatus for a portable terminal having a battery mounting groove formed on a surface thereof, a battery pack adapted to be fastened on and released from the battery mounting groove, and a locking apparatus for holding the battery pack which is mounted in the battery mounting groove, the locking apparatus including at least one locking groove formed on the battery pack and a locking button positioned adjacently to the battery mounting groove and having a locking protrusion protruding from a lateral wall of the battery mounting groove to be selectively engaged with the locking groove, wherein the locking button is adapted to linearly reciprocate parallel to the lateral wall of the battery mounting groove.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a portable terminal having a battery pack locking apparatus according to an embodiment of the prior art;

FIG. 2 is a perspective view showing a portable terminal having a battery pack locking apparatus according to another embodiment of the prior art;

FIG. 3 is a perspective view showing a portable terminal having a battery pack locking apparatus according to a preferred embodiment of the present invention;

FIG. 4 is an exploded perspective view showing how the battery pack locking apparatus shown in FIG. 3 is assembled to the terminal;

FIG. 5 is an exploded perspective view showing the battery pack locking apparatus shown in FIG. 3;

FIG. 6 is a perspective view showing the battery pack of the portable terminal shown in FIG. 3; and

FIGS. 7 to 10 illustrate the operation of the battery pack locking apparatus shown in FIG. 3.

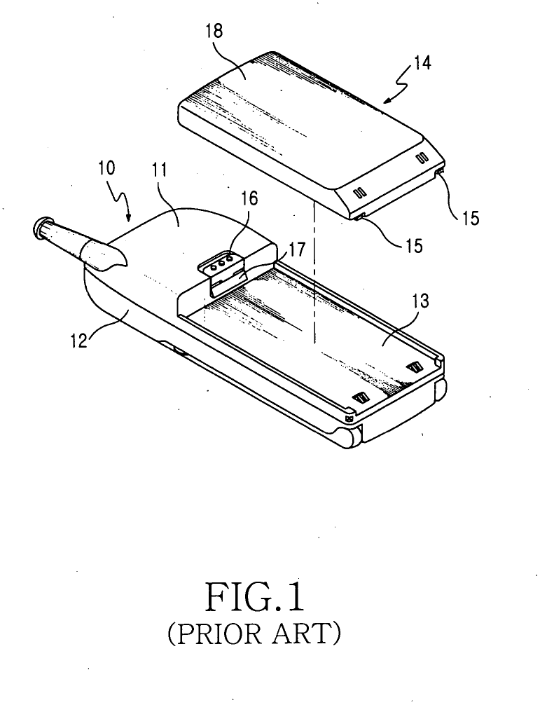

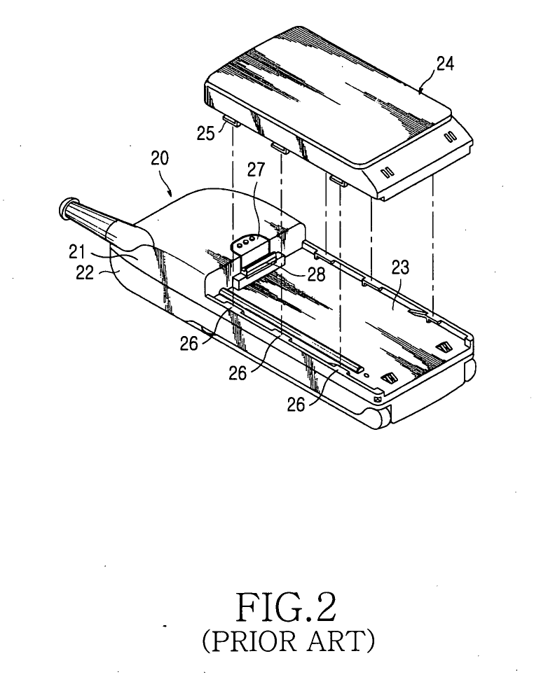

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

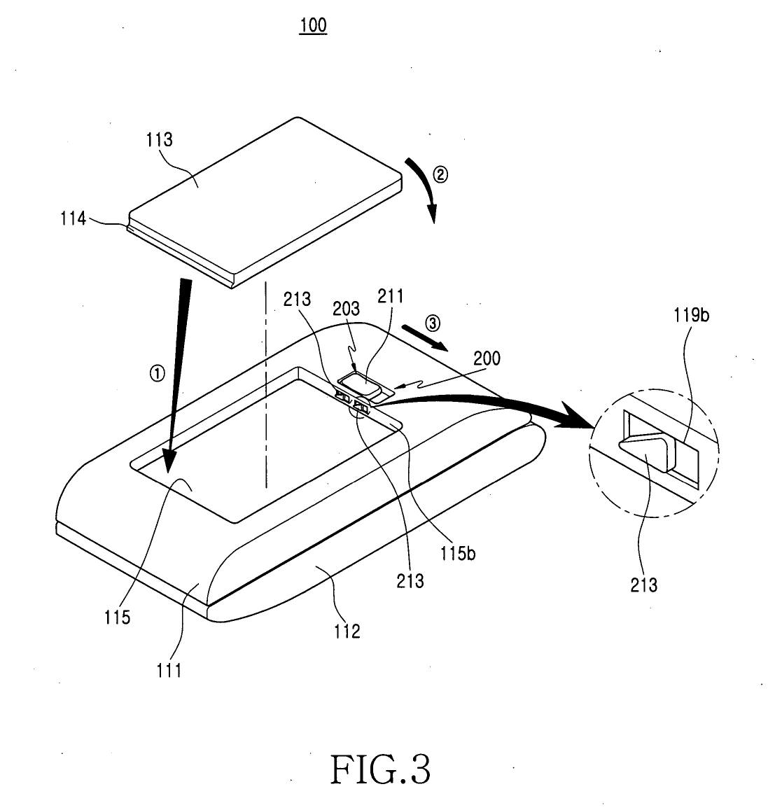

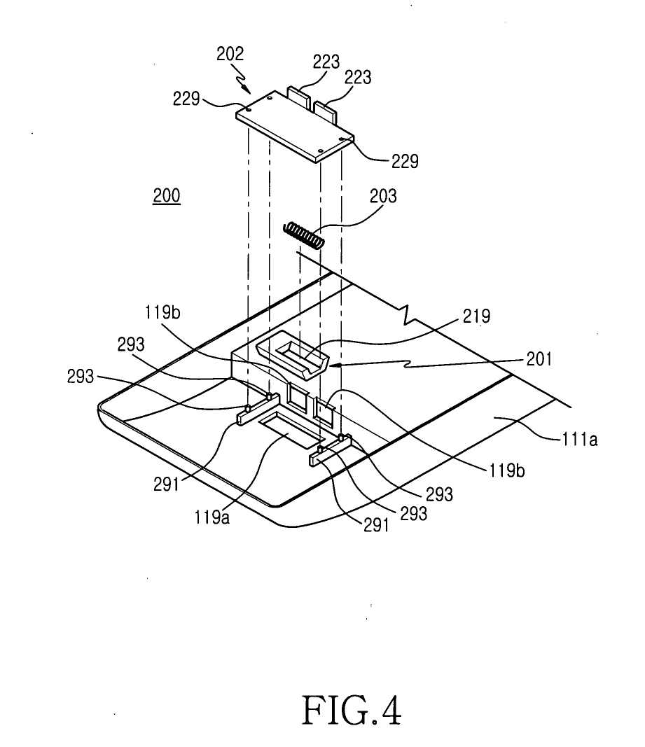

As shown in FIGS. 3 to 6, a battery pack 113 is secured by locking apparatus 200 to a portable terminal 100 according to a preferred embodiment of the present invention. Locking apparatus 200 includes a locking button 201 and a button cover 202 and is adapted to linearly reciprocate parallel to a lateral wall 115b of a mounting groove 115 of the terminal 100, in which the battery pack 113 is mounted, to gradually release the battery pack 113 from the battery mounting groove 115.

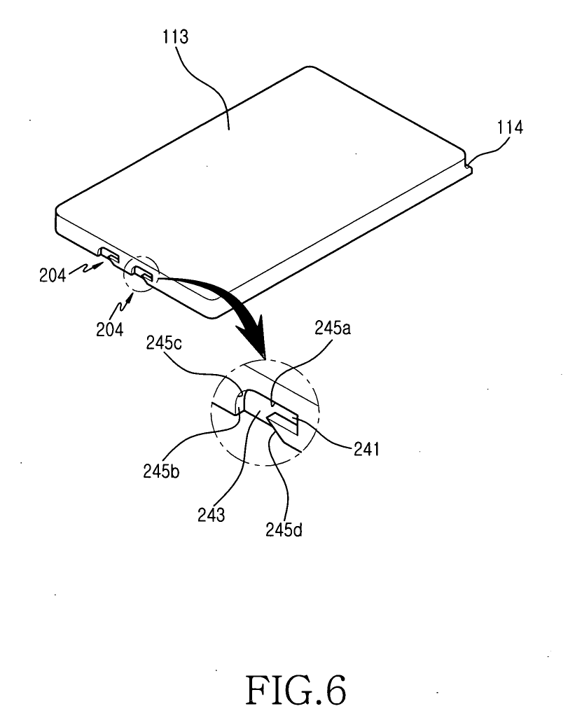

The portable terminal 100 has first and second housings 111 and 112, which can be folded on each other. The battery pack 113 is mounted in the battery mounting groove 115 formed on the rear surface of the first housing 111. The battery mounting groove 115 is recessed a predetermined depth from the rear surface of the first housing 111 in such a manner that, when the battery pack 113 is mounted therein, only the outer surface of the battery pack 113 is exposed. The battery pack 113 has a support piece 114 formed on an end thereof to be supported on the mounting groove 115 and a locking groove 204 formed on the other end thereof (FIG. 6) to be engaged with the locking apparatus 200, so that the battery pack 113 can be fixedly positioned in the mounting groove 115.

Referring to FIG. 3, the battery pack 113 is held on the mounting groove 115 in the following manner: the support piece 114 of the battery pack 113 is supported on an end of the mounting groove 115 along arrow \textcircled{1} and the battery pack 113 is rotated along arrow \textcircled{2} to fasten it on the mounting groove 115. After being held in the mounting groove 115, the battery pack 113 can be separated by linearly moving the locking button 201 [PLEASE ADD 201 IN FIG. 3] along arrow \textcircled{3}.

The construction and function of the locking apparatus 200 will now be described in detail.

The locking button 201 includes a button body 211, a locking protrusion 213, and a support rib 215. The locking button 201 is coupled to the inner surface of a rear case 111a of the first housing 111 in such a manner that it can slide and is provided with an elastic force in a first direction. The rear case 111a has a button opening 119a formed adjacently to the battery mounting groove 115 and a locking opening 119b formed on a lateral wall of the mounting groove 115. When the locking button 201 is coupled to the rear case 111a, the button body 211 and the locking protrusion 213 are exposed through the button opening 119a and the locking opening 119b, respectively. As such, the locking protrusion 213 protrudes out of the lateral wall 115b.

The button body 211 is exposed through the button opening 119a and is used as a handle operated by a user to separate the battery pack 113 from the portable terminal 100. The button body 211 is linearly moved against the elastic force on the outer peripheral surface of the terminal 100 in a direction parallel to the lateral wall 115b of the mounting groove 115.

The support rib 215 extends from the outer peripheral surface of the button body 211. From a different view of the locking button 201, it could also be said that the button body 211 protrudes from the upper surface of the support rib 215. When the locking button 201 is coupled to the inner surface of the rear case 111a, the support rib 215 is supported on the inner surface of the rear case 111a in such a manner that it can slide. The button opening 119a is completely closed by the support rib 215 when the locking button 201 is coupled to the rear case 111a. The support rib 215 still closes the button opening 119a even when the locking button 201 is linearly moved. The support rib 215 has a spring groove 219 formed on the lower surface thereof, in which a spring 203 is contained for providing the elastic force to the locking button 201 in the first direction.

A pair of locking protrusions 213 extend parallel to each other from the outer peripheral surface of the button body 211, more specifically from the outer peripheral surface of the support rib 215, and have a second slant surface 217 formed on the upper surface thereof with a slant in a direction.

As the locking button 201 linearly reciprocates on the terminal 100, the battery pack 113 is separated from the mounting groove 115. The button cover 202 is held on the inner surface of the rear case 111a of the terminal 100 and supports the lower surface of the locking button 201, in order to prevent the locking button 201 from being released from the rear case 111a.

In one embodiment, the rear case 111a has a holding rib 291 formed on the inner surface thereof and holding protrusions 293 protruding from the holding ribs 291, in order to hold the button cover 202. The button cover 202 has holding holes 229 formed thereon, which correspond to the holding protrusions 293. When the holding protrusions 293 and the holding holes 229 are engaged with each other, they may be glued or melted to each other in order to completely hold the button cover 202 on the rear case 111a.

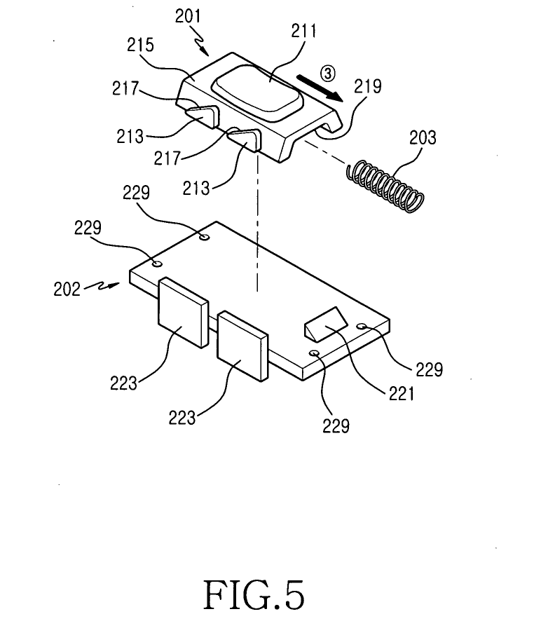

As best seen in FIG. 5, the button cover 202 has a pair of cover plates 223 formed on a lateral end thereof for closing the locking openings 119b and a support protrusion 221 formed on a surface thereof for supporting an end of the spring 203, which is contained in the spring groove 219 of the locking button 201. As such, the spring 203 has an end supported on an end wall of the spring groove 219 and the other end supported on the support protrusion 221 to provide an elastic force.

The protrusion 221 closes an open end of the spring groove 219 and is adapted to slide in the spring groove 219, as the locking button 201 slides on the terminal 100.

When the button cover 202 is coupled to the rear case 111a, while the locking button 201 is coupled on the rear case 111a, the button cover 202 supports the lower surface of the locking button 201 and closes the locking openings 119b. Consequently, the locking button 201 can be moved linearly without being released from the rear case 111a.

Referring to FIG. 6, the locking groove 204, which is formed on the other end of the battery pack 113, includes a locking portion 241 extending along the traveling direction of the locking button 201 and a movement portion 243 extending from an end of the locking portion 241 toward the lower surface of the battery pack 113, in a curved shape.

The locking portion 241 is engaged with the locking protrusion 213, when the battery pack 113 in mounted in the mounting groove 115, and prevents the battery pack 113 from being released from the mounting groove 115. The spring 203 provides an elastic force in such a direction that the locking protrusion 213 is positioned in the locking groove 204.

A lateral wall 245a of the locking portion 241 is connected to a lateral wall 245b of the movement portion 243 via a curved surface 245c. The lateral wall 245b of the movement portion 243 can be configured only by a curved surface extending from the lateral wall 245a of the locking portion 241. For example, the lateral wall 245b of the movement portion 243 may be configured by a planar surface, as in the present embodiment, connected with a curved surface 245c extending from the lower surface of the battery pack 113 in a direction perpendicular to the lateral wall 245a of the locking portion 241.

The other lateral wall of the movement portion 243 provides a first slant surface 245d extending with a slant while facing the lateral wall 245b of the movement portion 243 in such a manner that, the closer to the lower surface of the battery pack 113, the wider the movement portion 243 becomes. The first slant surface 245d is adapted to selectively face the second slant surface 217 of the locking protrusion 213.

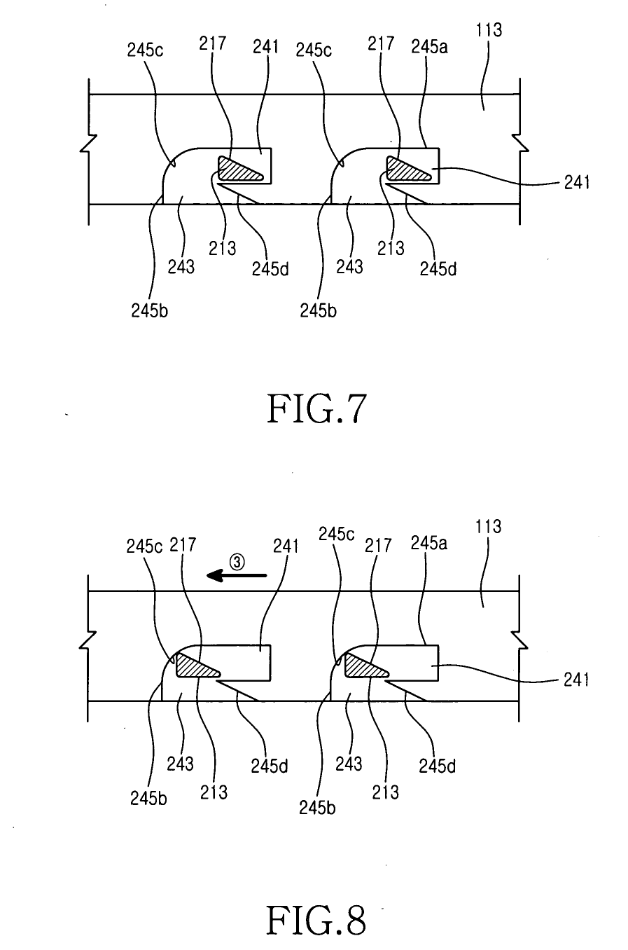

The separation of the battery pack 113 from the mounting groove 115 by the locking apparatus 200 will now be described with reference to FIGS. 7 to 10.

FIG. 7 shows the locking protrusion 213 which is positioned in the locking portion 241 of the locking groove 204, while the battery pack 113 is coupled to the mounting groove 115. The spring 203, which is contained beneath the locking button 201, provides an elastic force in such a direction that the locking protrusion 213 is positioned in the locking portion 241. Consequently, the locking protrusion 213 cannot travel toward the movement portion 243 as long as no external force is applied.

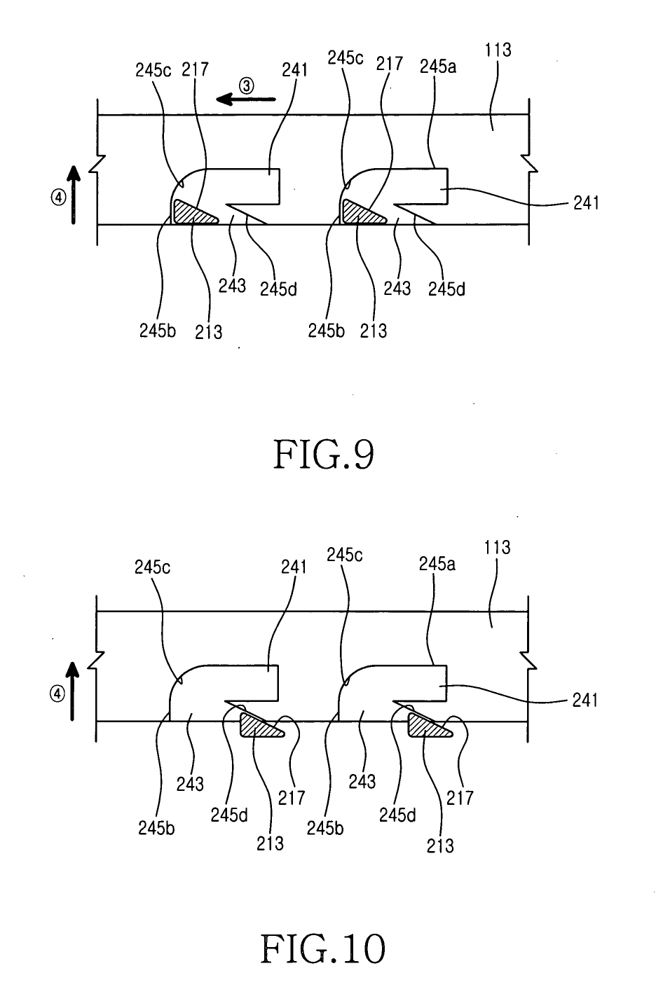

FIGS. 8 and 9 show the locking button 201 which is moved by an external force, e.g., through a user's operation, along arrow \textcircled{3}. As the locking button 201 is moved by an external force, the locking protrusion 213 travels along arrow \textcircled{3} and pushes against the curved surface 245c of the locking groove 204 with its upper end. The battery pack 113 is then moved along arrow \textcircled{4} and is released from the mounting groove 115. As soon as the upper end of the locking protrusion 213 contacts the curved surface 245c, the locking protrusion 213 is positioned on the movement portion 243 and allows the battery pack 113 to be released from the mounting groove 115, as seen in FIG. 10.

When the locking protrusion 213 is fully moved along arrow \textcircled{3} and contacts a lateral wall of the movement portion 243, as shown in FIG. 9, the first slant surface 245d of the movement portion 243 faces the second slant surface 217 of the locking protrusion 213.

If the external force, which has been moving the locking button 201 along arrow \textcircled{3}, is removed while the first slant surface 245d faces the second slant surface 217, the locking button 201 is moved by an elastic force provided by the spring 203 in a direction opposite to the arrow \textcircled{3}.

As the locking button 201 is moved in a direction opposite to the arrow \textcircled{3}, the second slant surface 217 pushes the first slant surface 245d upward. The battery pack 113 is then additionally moved along arrow \textcircled{4} and is completely separated from the mounting groove 115, as seen in FIG. 10.

When using conventional battery pack locking apparatuses, users have to manually separate the battery pack from the mounting groove even after the battery pack is unlocked. However, the battery pack 113 locking apparatus 200 according to the present invention, as mentioned above, is configured in such a manner that the battery pack 113 is separated from the mounting groove 115 by simply operating the locking button 201.

The mounting procedure of the battery pack 113 will now be described with reference to FIG. 3. The support piece 114, which is positioned on an end of the battery pack 113, is supported on an end of the mounting groove 115 along arrow \textcircled{1}. The battery pack 13 is then rotated along arrow \textcircled{2}. While the battery pack 113 is fastened on the mounting groove 115, the first surface 245d pushes against the second slant surface 217 and moves the locking protrusion 213 along arrow \textcircled{3}.

If the battery pack 113 is further rotated along arrow \textcircled{2} and is fastened on the mounting groove 115, the second slant surface 217 is moved out of the way of the first slant surface 245d, as shown in FIG. 8, and the locking protrusion 213 is positioned on the locking portion 241. The elastic force from the spring 203 then moves the locking protrusion 213 along arrow \textcircled{3} of FIG. 3. As a result, the locking protrusion 213 is completely engaged with the locking portion 241, and the battery pack 113 is completely held in the mounting groove 115.

As mentioned above, the battery pack locking apparatus for a portable terminal according to the present invention is advantageous in that the battery pack, which is held in the mounting groove, is unlocked by simply operating the locking button and is simultaneously separated from the mounting groove in a convenient manner. In addition, the battery pack is completely contained in the mounting groove, except for the outer surface thereof. This prevents the battery pack from being damaged and causes it to be firmly held continuously. Since the exposure of the components for mounting the battery pack is minimized, the durability of the battery pack mounting structure is improved.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A battery pack locking apparatus for a portable terminal, comprising:
at least one locking groove formed on the battery pack; and
at least one locking protrusion positioned on the terminal so that it linearly reciprocates and is adapted to engage with the locking groove while the battery pack is mounted on the terminal, wherein the battery pack is adapted to be released from the terminal as the locking protrusion linearly reciprocates in the locking groove when the locking protrusion is engaged with the locking groove.

2. A battery pack locking apparatus for a portable terminal as claimed in claim 1, wherein the locking groove comprises:
a locking portion extending in a direction parallel to an upper and lower surface of the battery pack; and
a movement portion extending from an end of the locking portion toward the lower surface of the battery pack in a curved shape.

3. A battery pack locking apparatus for a portable terminal as claimed in claim 2, wherein a lateral wall of the locking portion and a lateral wall of the movement portion, which extends from the lateral wall of the locking portion, are connected to each other by a curved surface.

4. A battery pack locking apparatus for a portable terminal as claimed in claim 2, wherein the locking protrusion is positioned at an end of the locking portion opposite to the movement portion when the battery pack is mounted on the terminal in a locked state.

5. A battery pack locking apparatus for a portable terminal as claimed in claim 4, wherein the locking protrusion has a spring for providing an elastic force in a direction towards the end of the locking portion opposite to the movement portion when the battery pack is mounted on the terminal in a locked state.

6. A battery pack locking apparatus for a portable terminal as claimed in claim 3, wherein the locking protrusion is adapted to travel linearly, when the battery pack is mounted in the terminal, and to push against the curved surface between the lateral walls of the locking portion and the movement portion so that the battery pack is pushed out of and released from the terminal.

7. A battery pack locking apparatus for a portable terminal as claimed in claim 3, wherein an other lateral wall of the movement portion provides a first slanted surface.

8. A battery pack locking apparatus for a portable terminal as claimed in claim 7, wherein the locking protrusion is provided with a second slant surface adapted to slidingly engage with the first slanted surface when the battery pack is released from the terminal.

9. A battery pack locking apparatus for a portable terminal as claimed in claim 8, wherein the locking protrusion is adapted to travel linearly so that upon engaging of the first and second slanted surfaces, the second slanted surface pushes against the first slanted surface upwardly whereupon the battery pack disengages from the terminal.

10. A battery pack locking apparatus for a portable terminal having a battery mounting groove formed on a surface thereof, a battery pack adapted to be fastened on and released from the battery mounting groove, comprising:
at least one locking groove formed on the battery pack; and
a locking button positioned adjacently to the battery mounting groove and having a locking protrusion protruding from a lateral wall of the battery mounting groove which selectively engages with the locking groove, wherein the locking button is adapted to linearly reciprocate parallel to a lateral wall of the battery mounting groove.

11. A battery pack locking apparatus for a portable terminal as claimed in claim 10, wherein the locking button has a button body exposed to the outside of the terminal, the locking button being adjacent to the battery mounting groove, and the locking protrusion extends away from the button body.

12. A battery pack locking apparatus for a portable terminal as claimed in claim 11, wherein the locking button has a support rib which extends from the outer peripheral surface of the button body and is slidably supported on the inner surface of the terminal.

13. A battery pack locking apparatus for a portable terminal as claimed in claim 12, wherein the locking button is slidably retained by a button cover.

14. A battery pack locking apparatus for a portable terminal as claimed in claim 10, further comprising a spring for providing an elastic force in a direction that forces the locking protrusion to engage with the locking groove when the battery pack is mounted in the battery mounting groove.

15. A battery pack locking apparatus for a portable terminal as claimed in claim 14, wherein an end of the spring is supported by the locking button and the other end is supported by a button cover of the locking button.

16. A battery pack locking apparatus for a portable terminal as claimed in claim 10, wherein the locking groove comprises:
a locking portion extending in a direction parallel to an upper and lower surface of the battery pack; and
a movement portion extending from an end of the locking portion toward the lower surface of the battery pack in a curved shape, and a lateral wall of the locking portion and a lateral wall of the movement portion, which extends from the lateral wall of the locking portion, are connected to each other by a curved surface.

17. A battery pack locking apparatus for a portable terminal as claimed in claim 16, wherein another lateral wall of the movement portion provides a first slanted surface.

18. A battery pack locking apparatus for a portable terminal as claimed in claim 16, wherein the locking protrusion is adapted to travel linearly and to push against the curved surface between the lateral walls of the locking portion and the movement portion so that the battery pack is released from the terminal.

19. A battery pack locking apparatus for a portable terminal as claimed in claim 17, wherein the locking protrusion is provided with a second slanted surface adapted to slidingly engage the first slanted surface when the battery pack is released from the terminal, and the locking protrusion is adapted to travel linearly in such a direction that the second slanted surface pushes against the first slanted surface upward upon such engagement so that the battery pack is completely separated from the terminal.

20. A battery pack locking apparatus for a portable terminal as claimed in claim 18, wherein the locking protrusion is provided with a second slanted surface adapted to slidingly engage the first slanted surface when the battery pack is released from the terminal, and the locking protrusion is adapted to travel linearly in such a direction that the second slanted surface pushes against the first slanted surface upward upon such engagement so that the battery pack is completely separated from the terminal.
